(19) United States
(12) Patent Application Publication
(10) Pub. No.: US 2007/0133473 A1
(43) Pub. Date: Jun. 14, 2007

(54) WIRELESS COMMUNICATION APPARATUS AND WIRELESS COMMUNICATION METHOD

(76) Inventors: Masahiro Takagi, Tokyo (JP); Yoriko Utsunomiya, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/557,636

(22) Filed: Nov. 8, 2006

(30) Foreign Application Priority Data
Nov. 9, 2005 (JP) 2005-325252

(51) Int. Cl. H04Q 7/00

(52) U.S. Cl. 370/334

(57) ABSTRACT

A physical header detecting unit detects a physical header from a received signal in which a first received signal intensity of a first channel or a second received signal intensity of a second channel exceeds a first threshold value. A first carrier sense unit determines that a carrier is detected when the physical header is detected. A second carrier sense unit determines whether a carrier is detected by determining whether the first or second received signal intensity exceeds a second threshold value when a physical header is not detected. A control unit controls the second carrier sense unit such that the second threshold value is lowered to temporarily increase the sensitivity of carrier sense when the second carrier sense unit performs carrier sense regarding the second channel.

### CROSS-REFERENCE TO RELATED APPLICATIONS

This application is based upon and claims the benefit of priority from prior Japanese Patent Application No. 2005-325252, filed Nov. 9, 2005, the entire contents of which are incorporated herein by reference.

### BACKGROUND OF THE INVENTION

1. Field of the Invention

The present invention relates to a wireless communication apparatus and a wireless communication method for performing media access control on the basis of a carrier sense state.

2. Description of the Related Art

Media access control (MAC) is control which determines how to use medium which is shared by a plurality of communication apparatuses to transmit communication data. Owing to arbitration by media access control, even if two or more communication apparatuses try to transmit communication data by using the same medium at the same time, there is less chance of the occurrence of a phenomenon (collision) in which a communication apparatus on the receiving side cannot separate communication data.

Although a communication apparatus having a transmission request is present, an event in which a media is not used by any communication apparatus slightly occurs.

In wireless communication, it is difficult that a communication apparatus monitors transmitted data while transmitting the data. For this reason, media access control performed without assuming collision detection is necessary. In IEEE802.11 which is a typical technical standard of a wireless LAN (Local Area Network), CSMA/CA (Carrier Sense Multiple Access with Collision Avoidance) is employed.

In the CSMA/CA in IEEE802.11, in a header of a MAC frame, a period of time (called “duration”) until a series of sequences including one or more frame exchanges subsequent to the MAC frame are finished is set. A communication apparatus which has a right of transmission regardless of the sequence in the duration waits for transmission by determining a virtual occupation state of a media. In this manner, collision is avoided from occurring. On the other hand, a communication apparatus having the right of transmission in the sequence recognizes that a media is not used except for a period in which the media is actually occupied.

A carrier sense of a physical layer in IEEE802.11, for example, as is regulated in Clear Channel Assessment (CCA) of IEEE802.11a, is a combination of a carrier sense which determines busy because a received signal simply exceeds a specified threshold value and a carrier sense which determines busy because a physical frame of IEEE802.11a is detected. In a 20-MHz channel, a threshold value of −62 [dBm] is regulated for the former, and a threshold value is regulated for the latter such that detection is performed at a sensitivity of −82 [dBm] with a probability of 90% within 4 [μLsec].

In IEEE802.11, it is regulated that a state of a media is determined by a combination between a virtual carrier sense of a MAC layer and a physical carrier sense of a physical layer, and media access control is performed based on the state of the media.

In IEEE802.11 employing CSMA/CA, a communication speed has been mainly increased by changing protocols of physical layers. With respect to a 2.4 GHz band, transition from IEEE802.11 (established on 1997, and having a communication speed=2 Mbps) to IEEE802.11b (established on 1999, and a communication speed=11 Mbps) and to IEEE802.11g (established on 2003, and having a communication speed=54 Mbps) has been performed. With respect to a 5-GHz band, at present, only IEEE802 11a (established on 1999, and having a communication speed=54 Mbps) exists as a standard of measure.

On the other hand, in order to establish a new standard of measure aiming at a further high speed in both the 2.4-GHz band and the 5-GHz band, IEEE802.11 TGn (Task Group n) has already been established. In the new standard, when the same frequency band as that in the existing standard (IEEE802.11b/g/a) is used, it is important that a communication apparatus conforming to the new standard is coexistent with a communication apparatus conforming to the existing standard and further preferably has downward compatibility. For this reason, the protocol of the MAC layer basically preferably conforms to CSMA/CA matched with the existing standard.

As one of the approaches to an increase in communication speed, a method of increasing the frequency bandwidth of a channel is known. When a new standard uses a frequency band which has not been used, coexistence and downward compatibility are not posed as problems. However, since frequencies are valuable resources, a new channel having a new frequency bandwidth is preferably allocated to a frequency band which has already been used. For example, one new channel effectively includes a plurality of existing channels to improve spectral efficiency.

Therefore, in order to cause a communication apparatus conforming to a new standard to maintain coexistence and downward compatibility with a communication apparatus conforming to the existing standard, when communication is performed by using a new channel, not only carrier sense of the new channel but also carrier sense of a plurality of existing channels having frequencies overlapping the frequency of the new channel must be performed.

EWC MAC Specification Version V1.0 Sep. 12th, 2005, specifies a protocol which performs media access control by the same CSMA/CA as that in IEEE802.11. In the protocol, communications are allowed to be switched in units of frames between a 20-MHz frame and a 40-MHz frame. Before each frame is transmitted, carrier sense must be performed to a channel required by the frame. How to perform carrier sense of a 40-MHz channel having a frequency band overlapping the frequency band of two 20-MHz channels is described. In this carrier sense method, a CCA result of a 20-MHz control channel and a CCA result of a 20-MHz extension channel are combined to each other to obtain a CCA result of a 40-MHz channel.

This carrier sense has a technical problem of deterioration of media access control efficiency caused when mutual interference between wireless network systems occurs in relation to a 20-MHz extension channel.

Media access to a 20-MHz control channel and media access to a 40-MHz channel are allowed to be performed adjacently in time series. In parallel with a frame exchange in a 20-MHz control channel performed by a certain wireless communication terminal, a situation in which an action of another frame exchange even in a 20-MHz extension channel is performed is assumed. In this situation, the frame exchange in the 20-MHz extension channel is independently performed by another wireless network system which is present in an interference area of the wireless communication terminal.

In general, when a certain wireless communication terminal is transmitting or receiving a frame of a 20-MHz control channel, simultaneous reception of the frame of the 20-MHz extension channel is technically difficult or is not worth the cost. Therefore, when a predetermined period of time has elapsed after an immediately previous frame exchange in the 20-MHz control channel is completed (according to the regulations of IEEE802.11, when SIFS time has elapsed), the wireless communication terminal which tries to access a 40-MHz channel starts carrier sense. At this time, the head of a physical frame in the 20-MHz control channel is probably captured. However, the probability of capturing the head of the physical frame in the 20-MHz extension channel becomes relatively low. More specifically, the probability of capturing a halfway part of the physical frame cannot be ignored. It is assumed that the communication terminal conforms to CCA regulated by IEEE802.11a. In this case, in detection of a physical frame having a sensitivity of −82 [dBm], a preamble at the head of the physical frame must be received, and a necessary synchronizing process must be performed.

Therefore, when the halfway part of the physical frame is captured, unless signal exceeding −62 [dBm] is received, the 20-MHz extension channel is determined as a channel in an empty (idle) state. If the 20-MHz control channel is also in an empty state, the entire 40-MHz channel is determined as a channel in an empty state, and a 40-MHz frame can be transmitted. However, since a situation in which interference which is stronger by 20 [dBm] than interference obtained when a physical frame can be detected occurs (i.e., a situation in which a distance between the wireless communication terminal and the interference source is small), the probability that a transmitted 40-MHz frame cannot be normally received by a destination terminal becomes high. In reverse, the 40-MHz frame interferes to increase the probability of preventing a frame exchange performed in an extension channel. In this manner, efficiency of media access control is deteriorated.

### BRIEF SUMMARY OF THE INVENTION

A wireless communication apparatus according to one aspect of the present invention comprises: a first transmitting unit which transmits a physical frame to a first channel having a first bandwidth; a second transmitting unit which transmits a physical frame to a second channel having a second bandwidth wider than the first bandwidth; a signal intensity measuring unit which measures a first received signal intensity of the first channel or a second received signal intensity of the second channel; a physical header detecting unit which detects at least a part of a physical header from a received signal in which the first received signal intensity or the second received signal intensity exceeds a first threshold value; a first carrier sense unit which obtains a first carrier sense result representing that a state in which a carrier is detected continues for a specific period of time designated by the physical header when the physical header is detected; a second carrier sense unit which obtains a second carrier sense result representing whether a carrier is detected, by determining whether the first or second received signal intensity exceeds a second threshold value when a physical header is not detected by the physical header detecting unit; a control unit which controls the second carrier sense unit such that the second threshold value is lowered to temporarily increase the sensitivity of carrier sense when the second carrier sense unit performs carrier sense with respect to the second channel; and a media access control unit which controls transmission of a physical frame by the first transmitting unit and the second transmitting unit on the basis of the first carrier sense result obtained by the first carrier sense unit and the second carrier sense result obtained by the second carrier sense unit.

### BRIEF DESCRIPTION OF THE SEVERAL VIEWS OF THE DRAWING

FIG. 1 is a block diagram showing a wireless communication apparatus according to an embodiment;

FIGS. 2A and 2B are diagrams showing format examples of a physical frame and a media access frame;

FIGS. 3A to 3C are diagrams showing detailed format examples of physical frames;

FIG. 4 is a diagram showing an example of two wireless network systems which interfere with each other;

FIG. 5 is a diagram for explaining a relationship between a configuration of a channel used by a wireless communication system and mutual interference;

FIG. 6 is a diagram showing a change of a ratio of an interference signal and a desired signal depending on a difference between sensitivities of carrier senses;

FIG. 7 is a diagram showing carrier sense state transition;

FIG. 8 is a diagram showing carrier sense mode state transition;

FIG. 9 is a diagram showing an example of a carrier sense determination reference in a carrier sense mode;

FIG. 10 is a diagram showing another example of the carrier sense determination reference in the carrier sense mode;

FIG. 11 is a diagram showing an internal configuration of a carrier sense unit;

FIG. 12 is a diagram showing an example of a frame sequence and a carrier sense;

FIG. 13 is a diagram showing another example of the frame sequence and the carrier sense;

FIG. 14 is a diagram showing media empty/full determination; and

FIG. 15 is a diagram showing a simple carrier sense determination reference used when a significant signal of an extension channel cannot be detected.

### DETAILED DESCRIPTION OF THE INVENTION

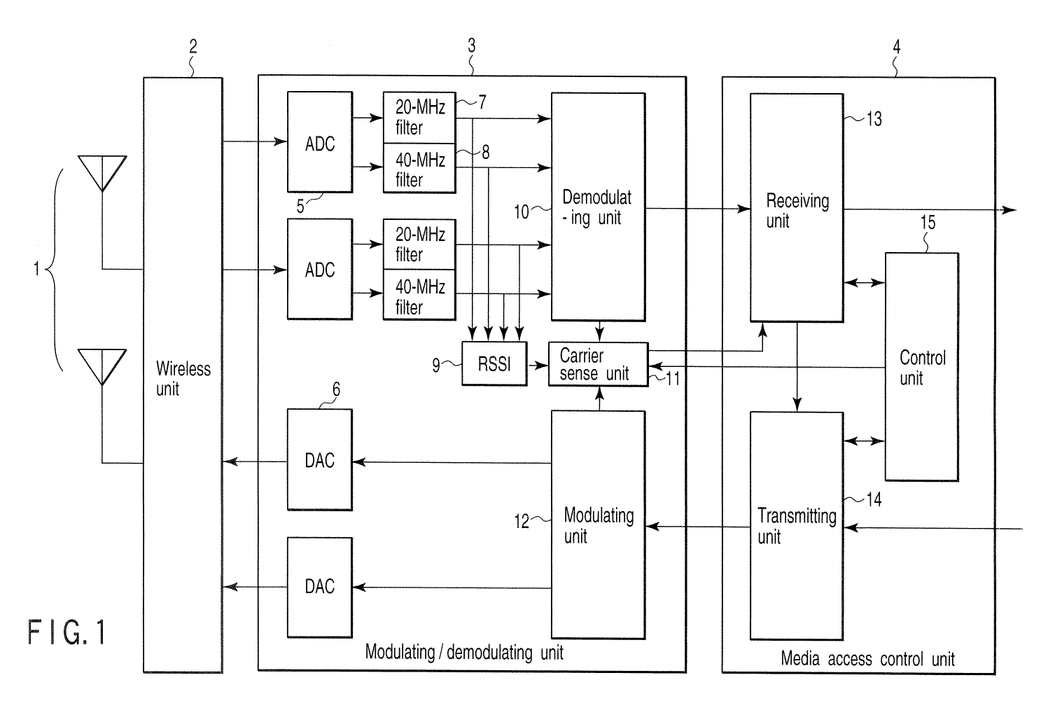

Referring to FIG. 1, as the wireless communication apparatus, there is supposed a wireless communication apparatus which can perform receiving/transmitting in conformity to, for example, IEEE802.11a/b/g, and which additionally has a function related to MIMO (Multiple Input Multiple Output) and extension of a channel bandwidth to 40 MHz, which is considered to be employed in IEEE802.11n. However, the wireless communication apparatus essentially performs media access control based on carrier sense to channels having different bandwidth and overlapping frequencies, and the function of MIMO is not essential for this embodiment. In addition, although not shown, a function of realizing an upper protocol layer of the media access control may be included.

The wireless communication apparatus shown in FIG. 1 includes an antenna 1, a wireless unit 2, a modulating/demodulating unit 3, and a media access control unit 4. The modulating/demodulating unit 3 includes an A/D converter (Analog Digital Converter: ADC) 5, a 20-MHz filter 7, a 40-MHz filter 8, a demodulating unit 10, an RSSI (Received Signal Strength Indication) unit 9, a carrier sense unit 11, a modulating unit 12, and a D/A converter (Digital Analog Converter: DAC). This configuration has an assumption that the filters 7 and 8 and the RSSI unit 9 are realized by digital processes. However, these components may be realized by analog processes in the wireless unit 2. The media access control unit 4 includes a receiving unit 13, a transmitting unit 14, and a control unit 15.

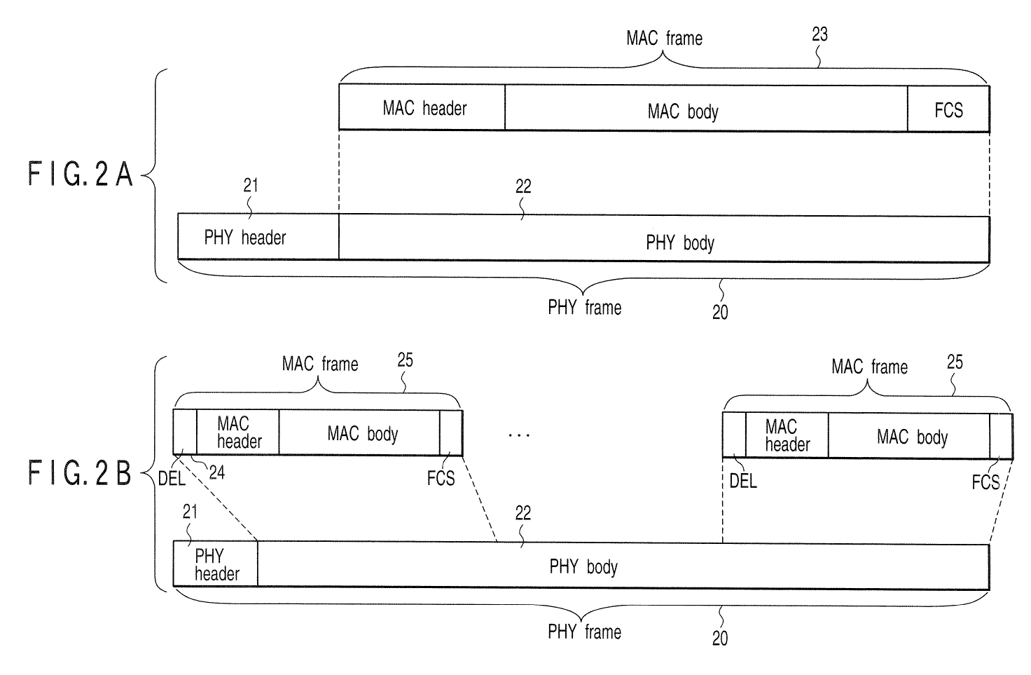

Referring to FIGS. 2A and 2B, a physical frame 20 is also called a PPDU (Physical layer Protocol Data Unit), and includes a PHY header 21 and a PHY body 22. The PHY header 21 includes a PLCP (Physical Layer Convergence Procedure) preamble and a PLCP header. The PHY body 22 is also called a PSDU (Physical layer Service Data Unit). FIG. 2A shows a format example obtained when a single physical frame 22 includes a single MAC frame (MAC Protocol Data Unit: MPDU) 23. FIG. 2B shows a format example obtained when the single physical frame 22 includes a plurality of MAC frames 25 delimited by delimiters (DEL) 24, i.e., when the plurality of MAC frames 25 are aggregated in the single physical frame 22. The delimiter 24 includes information such as the length of a MAC frame subsequent to the delimiter 24. The delimiter 24 is given on a transmitting side and used to cut out each MAC frame on a receiving side.

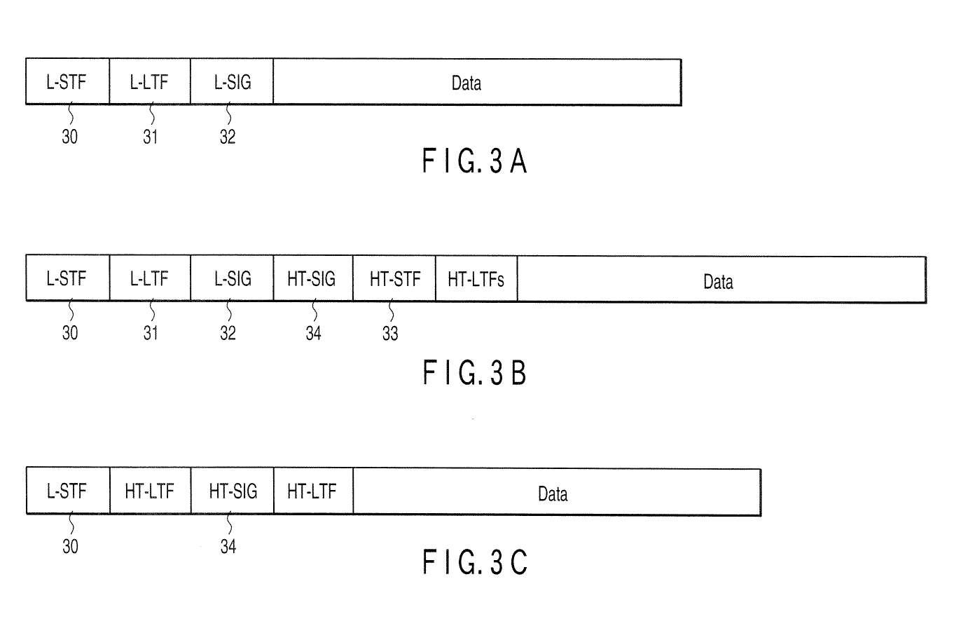

FIG. 3A shows, for example, a format specified in IEEE802.11a, where an L-STF (Legacy Short Training Field) 30 and an L-LTF (Legacy Long Training Field) 31 correspond to PLCP preambles, and an L-SIG (Legacy Signal Field) 32 corresponds to a PLCP header. In order to cause the wireless communication apparatus to detect a physical frame, the L-STF 30 must be received and detected. The detection is generally performed by a correlator. The L-SIG 32 includes information required to demodulate a physical frame. However, in this case, it is important that the L-SIG 32 especially includes the lengths of a transmission rate and a physical frame and information (parity) to detect an error. FIG. 3B shows an example of a format proposed in IEEE802.11n. Since the L-STF 30 to the L-SIG 32 are the same as those in the conventional art, even in a conventional wireless communication apparatus (wireless communication apparatus conforming to IEEE802.11a or IEEE802.11g), carrier sense can be performed on the basis of CCA specified by IEEE802.11a or IEEE802.11g with respect to a frame of IEEE802.11n. Elements subsequent to an HT-SIG 34 are required to demodulate MIMO.

The format shown in FIG. 3C is an example proposed in IEEE802.11n as in the format shown in FIG. 3B. However, the format is not compatible with a conventional wireless communication apparatus (wireless communication apparatus conforming to IEEE802.11a to IEEE802.11g), and a PHY header unit is omitted. In order to cause the wireless communication apparatus to detect a physical frame, the L-STF 30 must be received and detected. The HT-SIG 34 includes the lengths of a transmitting rate and a physical frame and information (parity) to detect an error.

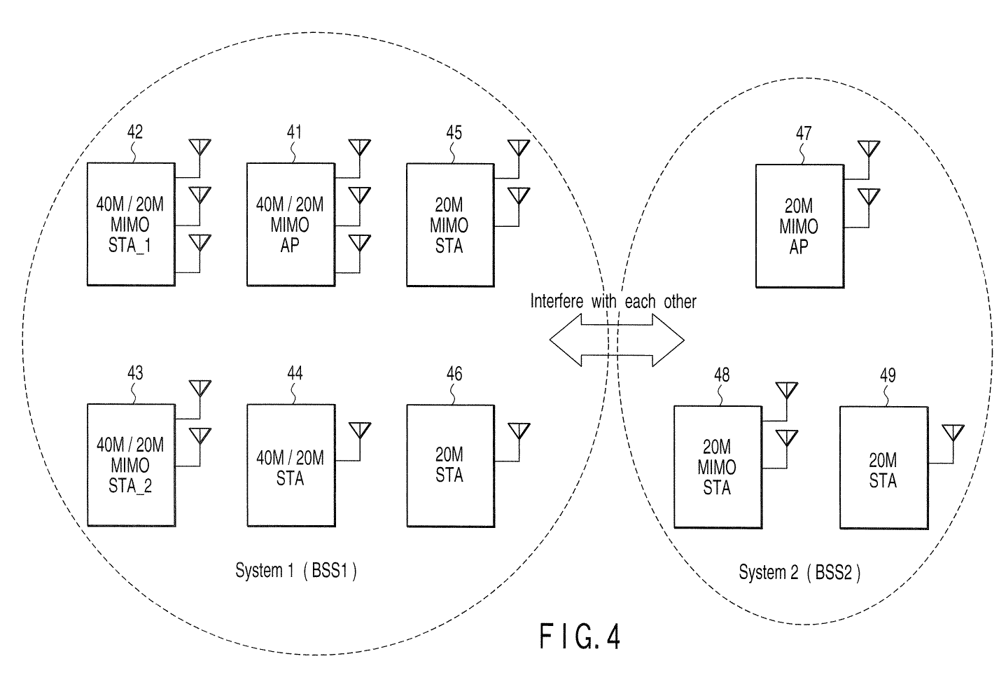

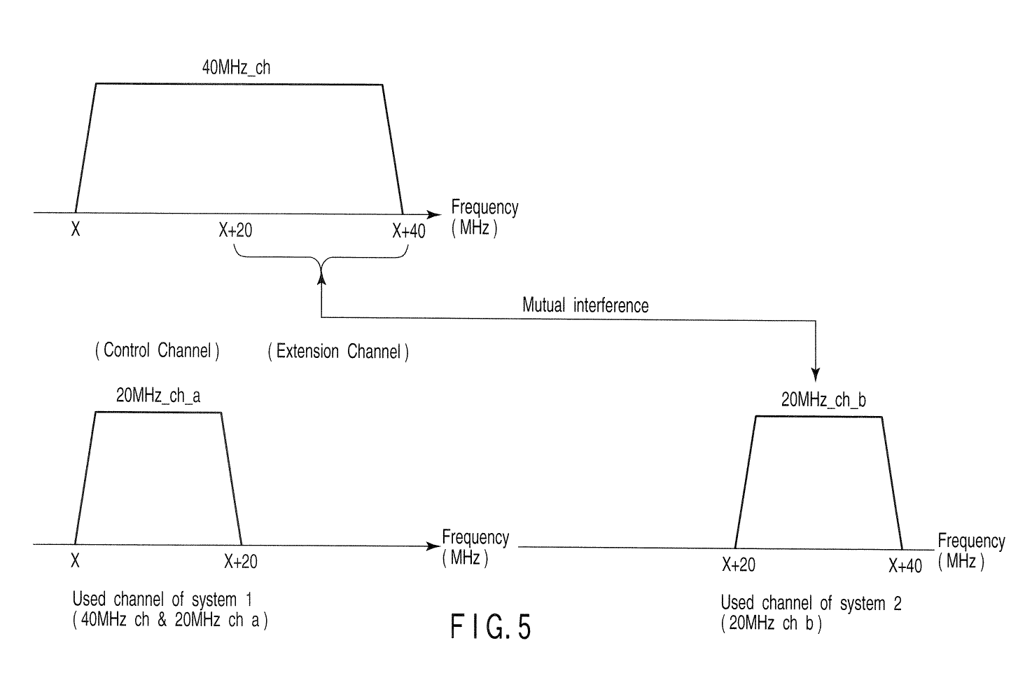

Referring to FIG. 4, a wireless network system 1 (BBS1: Basic Service Set 1) includes a wireless communication apparatus of a base station or a terminal station to which the present invention is applied, and the present invention is not applied to a wireless network system 2 (BSS2). The present invention is not applied to a wireless apparatus of a terminal station of the BSS1 which does not have a 40-MHz channel transmitting/receiving function and which performs only 20-MHz channel transmission/reception (20 MHz MIMO STA, 20 MHz STA). The wireless network system 1 (BBS1) and the wireless network system 2 (BBS2) have one base station each. A base station 41 in the wireless network system 1 is an access point corresponding to 40 MHz/20 MHz MIMO AP. Terminal stations 42 to 46 establish associations with the base station 41. The terminal station 42 is 40 MHz/20 MHz MIMO STA_1, the terminal station 43 is 40 MHz/20 MHz MIMO STA_2, the terminal station 44 is 40 MHz/20 MHz STA, the terminal station 45 is 20 MHz MIMO STA, and the terminal station 46 is 20 MHz STA.

A base station 47 in the wireless network system 2 is an access point corresponding to 20 MHz MIMO AP. Terminal stations 48 and 49 establish associations with the base station 47. The terminal station 48 is 20 M MIMO STA, and the terminal station 49 is 20 M STA.

Referring to FIG. 5, the wireless network system 1 uses 20 MHz_ch_a (control channel) of a frequency XMHZ to (X+20) MHz and 40-MHz channel of a frequency XMHZ to (X+40) MHz in main communication in the system. However, 20 MHz_ch_b (extension channel) of (X+20) MHz to (X+40) MHz may be used for interference control between the wireless network system and another wireless network system, media access control and the like. The wireless network system 2 uses 20 MHz_ch_b of frequencies (X+20) MHz to (X+40) MHz in communication in the system. The control channel and the extension channel are names called when the channels are viewed from the wireless network system 1.

Since frequencies used by the wireless network system 1 and the wireless network system 2 overlap in 20 MHz_ch_b (extension channel), communications may be interfered with each other. When a wireless network system 1 performs communication by using 40-MHz channel, media access control must be performed to reduce the probability of occurrence of interference. More specifically, the moment the wireless network system 2 uses 20 MHz_ch_b (extension channel when viewed from the wireless network system 1), media access control must be performed to avoid a 40-MHz frame from being transmitted. For this reason, carrier sense of an extension channel or carrier sense to an entire 40-MHz channel performed by the wireless communication apparatus belonging to the wireless network system 1 must be configured to make it possible to appropriately detect whether the 20 MHz_ch_b (extension channel) is used.

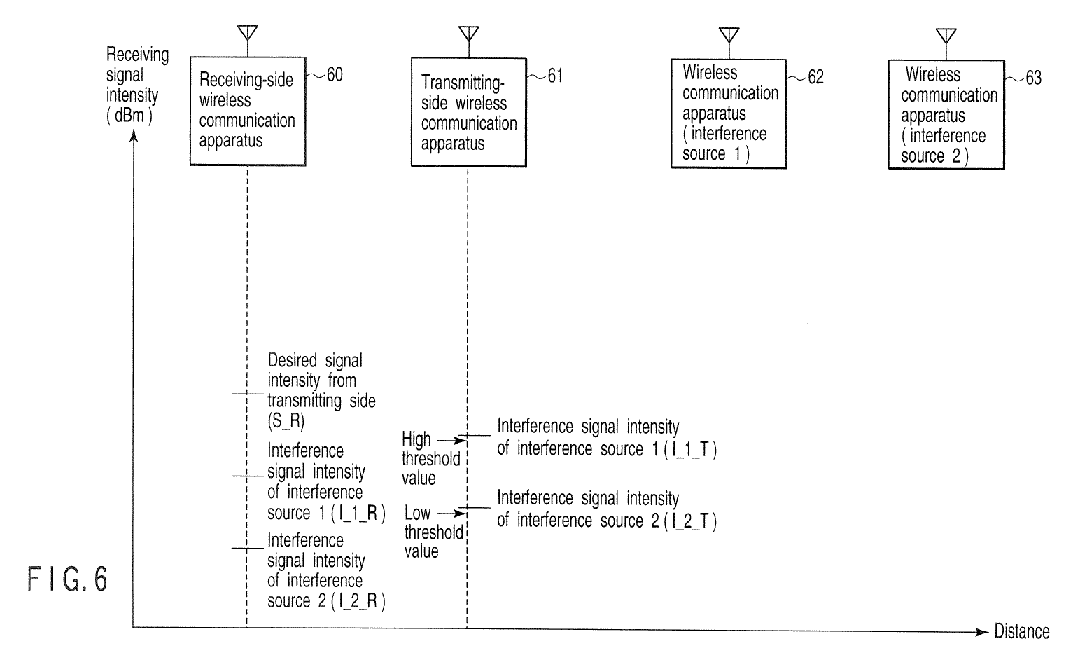

A change of a ratio of an interference signal and a desired signal depending on a difference of sensitivities of carrier senses will be described below with reference to FIG. 6. Suppose a situation when a transmitting wireless communication apparatus 61 performs carrier sense and determines that a channel is empty, and hence the transmitting wireless communication apparatus 61 performs transmission to a receiving wireless communication apparatus 60.

In this case, wireless communication apparatuses 62 and 63 serving as “interference sources” can be present to perform transmission simultaneously with the transmitting wireless communication apparatus 61. The wireless communication apparatus 62 serving as an interference source 1 is located at a position which is relatively close to the receiving and transmitting wireless communication apparatus 60 and 61. The wireless communication apparatus 63 serving as an interference source 2 is located at a position which is relatively far from the receiving and transmitting wireless communication apparatuses 60 and 61.

The following situation will be considered. That is, immediately after frame transmission/reception in a control channel (the transmitting wireless communication apparatus 61 and the receiving wireless communication apparatus 60 may not necessarily be related) is performed, the transmitting wireless communication apparatus 61 tries to transmit a frame to a 40-MHz channel obtained by combining the control channel and the extension channel. The wireless communication apparatus 62 serving as the interference source 1 or the wireless communication apparatus 63 serving as the interference source 2 has already started to transmit a physical frame at this time. That is, the transmission of the physical frame in the extension channel is performed in parallel with frame transmission/reception in the control channel. For this reason, it is assumed that the transmitting wireless communication apparatus 61 cannot capture the head of the physical frame. Therefore, the transmitting wireless communication apparatus 61 must detect the physical frame by carrier sense of an insignificant signal. An insignificant signal is a signal which does not include the feature of IEEE802.11 physical frames, which cannot be interpreted as IEEE802.11 physical frames.

As is apparent from FIG. 6, in the transmitting wireless communication apparatus 61, when a carrier sense threshold value of the insignificant signal is “high threshold value”, the physical frame transmitted by the wireless communication apparatus 62 serving as the interference source 1 can be detected, but the physical frame transmitted by the wireless communication apparatus 63 serving as the interference source 2 cannot be detected. On the other hand, when the carrier sense threshold value of the insignificant signal is a “low threshold value” in the transmitting wireless communication apparatus 61, both the physical frame transmitted by the wireless communication apparatus 62 serving as the interference source 1 and the physical frame transmitted by the wireless communication apparatus 63 serving as the interference source 2 can be detected.

A ratio of a signal to an interference signal in the receiving wireless communication apparatus 60 may decrease to S_R/I_1_R in the former. However, in the latter, the interference signal is improved to S_R/I_2_R. Therefore, when the transmitting wireless communication apparatus 61 sets the threshold value of the carrier sense of the insignificant signal at a low level (the sensitivity of the carrier sense is increased), the probability of being able to correctly decode a physical frame in the receiving wireless communication apparatus 60 increases. For example, when the low threshold value has a level almost equal to a signal intensity level at which a significant signal can be detected, an influence of interference can be reduced comparably to an influence obtained when the head of the physical frame can be received and detected as a significant signal.

Although not shown here in detail, if the transmitting wireless communication apparatus 61 increases the sensitivity of carrier sense, it causes the transmitting wireless communication apparatus 61 to be able to reduce an influence of interference caused by itself to communications by the wireless communication apparatuses 62 and 63.

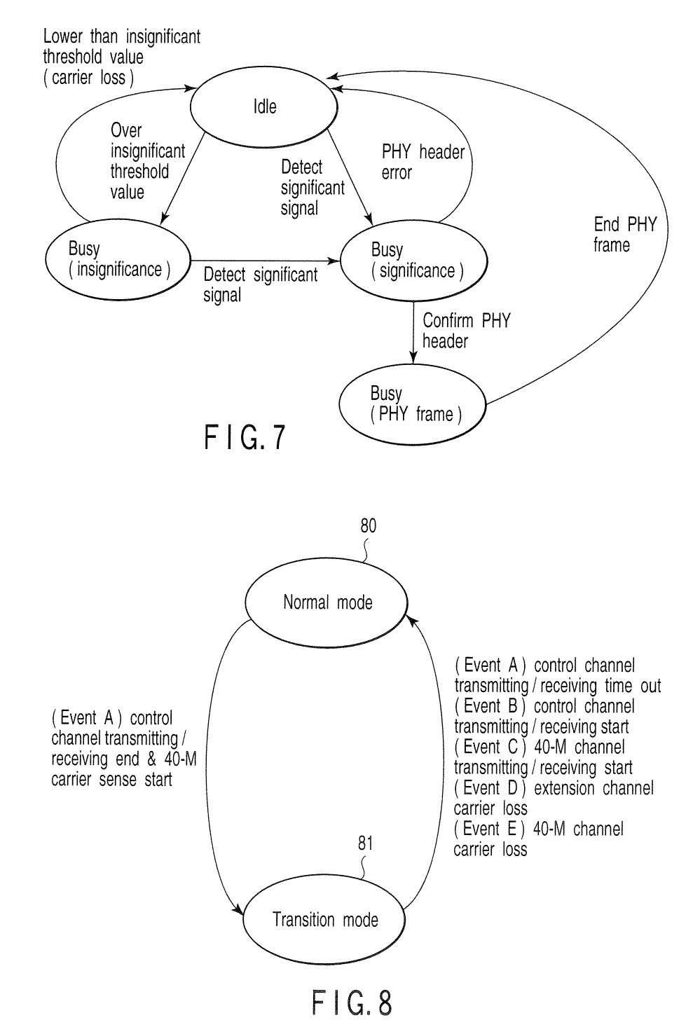

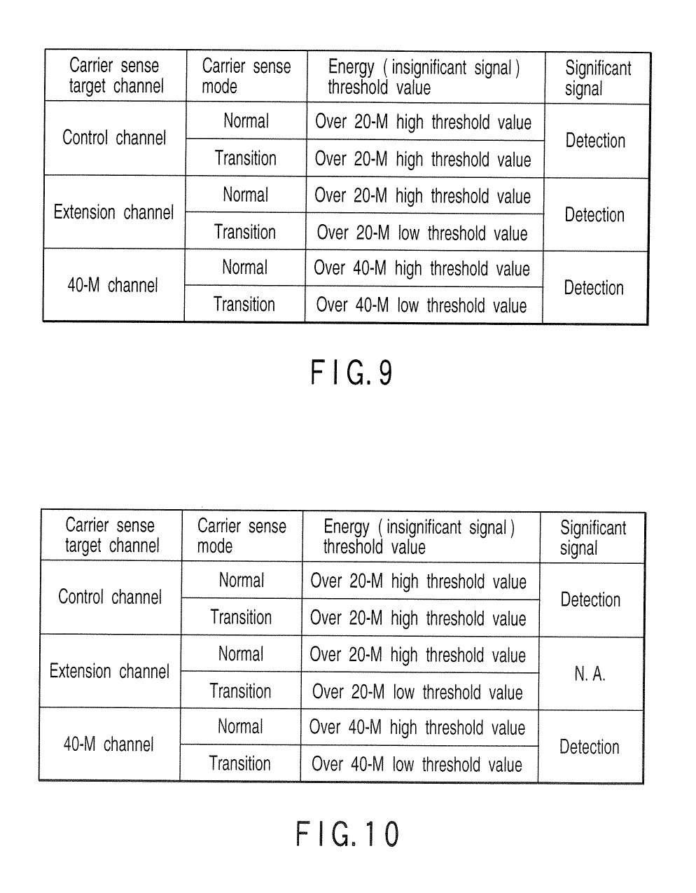

FIG. 7 is a diagram showing carrier sense state transition, FIG. 8 is a diagram showing carrier sense mode state transition, and FIGS. 9 and 10 are diagrams showing carrier sense determination reference applied according to carrier sense modes. The carrier sense determination reference in FIG. 9 is applied when a significant signal detection of an extension channel can be performed. The carrier sense determination reference in FIG. 10 is applied when a significant signal detection of the extension channel cannot be performed (Not Available).

A characteristic point of the embodiment is that, in carrier sense (CCA (Clear Channel Assessment) of IEEE802.11) in a physical layer, a determination reference of the carrier sense, i.e., an energy (insignificant signal) threshold value is changed depending on a mode change of the carrier sense as shown in FIG. 8.

In order to detect a significant signal in an extension channel, the wireless communication apparatus must include a function which can detect a physical frame in the extension channel and at least partially decode a physical header. However, in terms of an apparatus cost or operability, this function may be omitted. The carrier sense determination reference (when significant signal detection of the extension channel cannot be performed) in FIG. 10 is supposed to be applied to such an apparatus. Detection of an insignificant signal means that the energy of a received signal exceeds a threshold value.

In the carrier sense state transition in FIG. 7, when the received signal can be regarded as at least a part of a physical header, the received signal is determined as a significant signal, a carrier sense reference of a significant signal is applied, and other received signals are determined as insignificant signals, so that a carrier sense reference of the insignificant signal is applied. For example, the carrier sense state transition is obtained by abstracting and collecting contents specified at clauses such as “CCA”, “CCA Sensitivity”, “Receive PLCP” of IEEE802.11a specification. In many cases, the sensitivity of carrier sense to a significant signal is set to be higher than the sensitivity of carrier sense to an insignificant sense. For example, in case of IEEE802.11a, the sensitivity of a significant signal of a 20-MHz channel is regulated to −82 [dBm], and the sensitivity of an insignificant signal is regulated to −62 [dBm].

In IEEE802.11a, the sensitivity of a significant signal is set to be equal to the sensitivity of the lowest transmission rate (i.e., the highest sensitivity of −82 [dBm]). The sensitivity of the insignificant signal is set to be a sensitivity which is lower than the sensitivity of the highest transmission rate (i.e., the lowest sensitivity of −65 [dBm]) by 3 [dBm].

The carrier sense state transition shown in FIG. 7 is executed by the carrier sense unit 11 shown in FIG. 1. The intensity of a signal to be determined is input from the RSSI unit 9. The signal input to the RSSI unit 9 is performed through the 20-MHz filter 7 and the 40-MHz filter 8. These signals are used to measure signal intensities of a 20-MHz channel and a 40-MHz channel, respectively. When the signal intensities of the control channel and the extension channel are measured by the 20-MHz channel, one 20-MHz filter 7 may be used such that the 20-MHz filter 7 is switched for the control channel and the extension channel. Independent 20-MHz filters 7 may be also allocated to the control channel and the extension channel, respectively. A difference between signal intensities measured by the 20-MHz filter 7 for the control channel and the 40-MHz filter 8 may be used as a signal intensity of the extension channel. In contrast to this, a sum of signal intensities obtained by the 20-MHz filter 7 for the control channel and the 20-MHz filter 7 for the extension channel may be used as a signal intensity of a 40-MHz channel. In a configuration in which a plurality of antennas 1 are simultaneously used in reception as shown in FIG. 1, signals are input from the respective A/D converters 5 to the filters 7 and 8, respectively. Received signal intensities of a plurality of antennas 1 are appropriately added to each other to make a received signal intensity in each channel. In the configuration in FIG. 1, it is assumed that the filters 7 and 8 are realized by digital processes. However, the filters 7 and 8 may be realized by analog processes in the wireless unit 2.

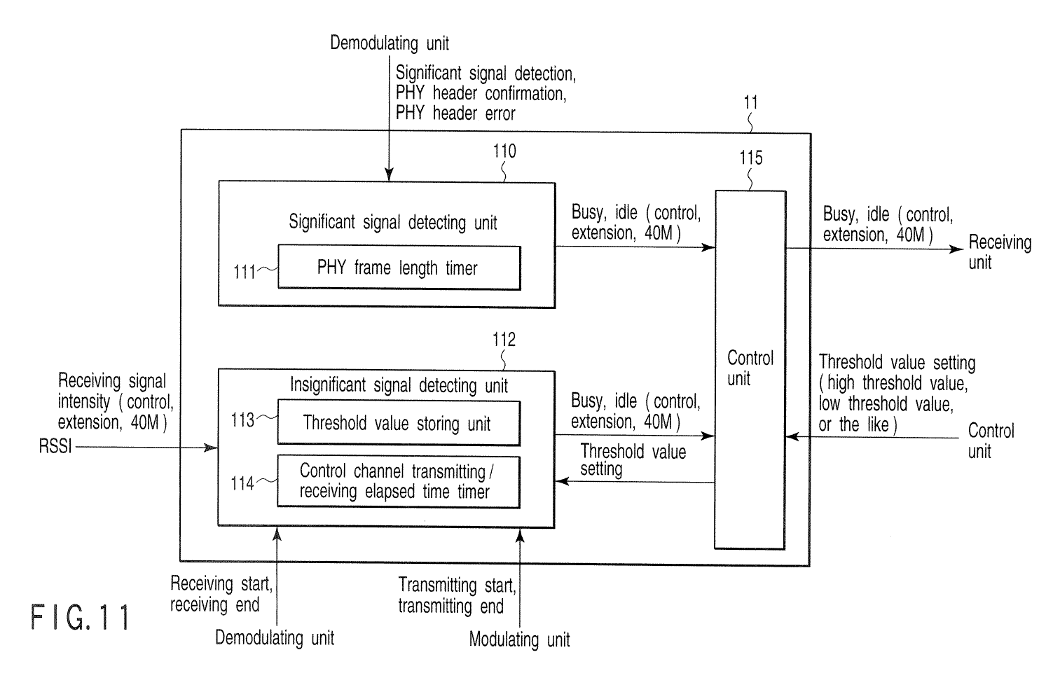

An internal configuration of the carrier sense unit 11 of FIG. 1 is shown in FIG. 11. The carrier sense unit 11 includes a significant signal detecting unit 110, an insignificant signal detecting unit 112, and a control unit 115.

The significant signal detecting unit 110 receives information of significant signal detection, PHY header confirmation, and a PHY header error from the demodulating unit 10. In particular, the PHY header confirmation may include information related to a transmission rate and the length of a PHY frame. The PHY header confirmation is used to calculate duration of the PHY frame and set a PHY frame length timer 111. By using these pieces of information, as described in FIG. 7, it is determined whether a carrier is detected (busy or idle).

The insignificant signal detecting unit 112 obtains a received signal intensity (control, extension, and 40 M) from the RSSI unit 9, compares the received signal intensity with a threshold value stored in a threshold storing unit 113 to determine whether carriers are detected in the control channel, the extension channel, and the 40-MHz channel (busy or idle). In order to avoid an influence of short-term noise, a received signal intensity obtained by averaging received signal intensities for a predetermined period of time may be used. The control unit 15 of the media access control unit 4 may set a threshold value through the control unit 115 of the carrier sense unit 11, or may be set at fixed values (set for a high threshold value and a low threshold value, respectively). The insignificant signal detecting unit 112 receives events of physical frame receiving start and end (control, extension, and 40 M) from the demodulating unit 10 and receives events of physical frame transmitting start and end (control, extension, and 40 M) from the modulating unit 12. These events are used in state transition control or the like explained with reference to FIGS. 7 and 8.

The control unit 115 of the carrier sense unit 11 integrates a carrier sense result of the significant signal detecting unit 110 and a carrier sense result of the insignificant signal detecting unit 112 and notifies the receiving unit 13 of the media access control unit 4 of the integration result. The control unit 115 of the carrier sense unit 11 transmits a threshold value setting or the like from the control unit 15 of the media access control unit 4 to the insignificant signal detecting unit 112 or the like.

As the threshold value of an insignificant signal held by the carrier sense unit 11, an appropriate threshold value may be selected depending on a situation from values set in advance. The control unit 15 of the media access control unit 4 shown in FIG. 1 may set a value depending on a situation (interference occurrence situation or the like in an environment in which the carrier sense unit 11 is arranged) to the carrier sense unit 11.

Carrier sense executed by the carrier sense unit 11 includes two modes, i.e., a normal mode and a transition mode. Transition between the modes is controlled by carrier sense mode state transition as shown in FIG. 8. It is mainly assumed that the normal mode is used when a channel with the same bandwidth is continuously accessed. In the mode, carrier sense conforming to conventional IEEE802.11a or the like is performed.

It is assumed that the transition mode is used when media access control is performed on the basis of carrier sense to a given channel having a certain bandwidth used in immediately previous frame transmission/reception and a channel having a bandwidth different from the certain bandwidth and a frequency area overlapping the frequency area of the given channel. Typically, a narrow-band channel is used in immediately previous frame transmission/reception, and the transition mode is used when carrier sense to access a broad-band channel including the narrow-band channel in a frequency area is performed. More specifically, the transition mode is used in the following case or the like. That is, after the transmission/reception of a 20-MHz frame in the control channel, a 40-MHz channel obtained by adding the control channel and the extension channel to each other is tried to be accessed.

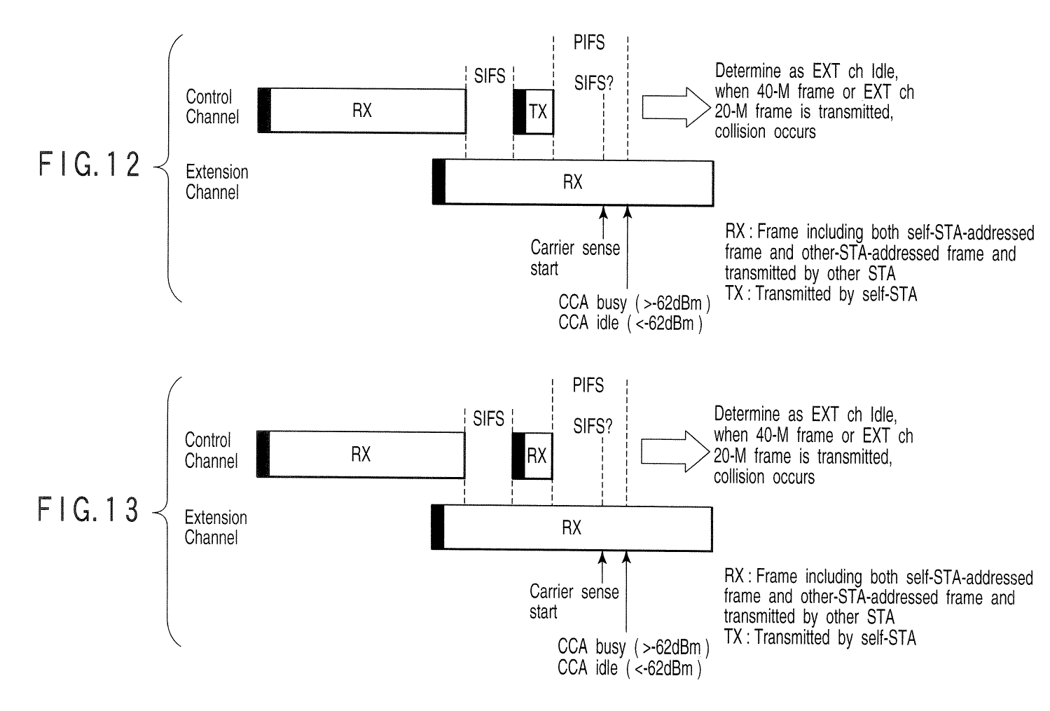

As described above, after the transmission/reception of the 20-MHz frame in the immediately previous control channel, when the 40-MHz channel is tried to be accessed, a technical problem such as deterioration of media access control efficiency is posed when mutual interference between wireless network systems occurs with respect to the 20-MHz extension channel. This problem will be described below with reference to FIGS. 12 and 13.

FIG. 12 shows a case in which a wireless communication terminal receives a frame (RX) in a 20-MHz control channel, and the wireless communication terminal tries to access a 40-MHz channel immediately after a response frame corresponding to the received frame is transmitted (TX) to the 20-MHz control channel. FIG. 13 shows a case in which immediately after frame reception (RX) from another wireless communication terminal in the 20-MHz control channel, the wireless communication terminal tries to access the 40-MHz channel.

Any one of the cases in FIGS. 12 and 13 shows a situation in which an action of a frame exchange is performed even in the 20-MHz extension channel in parallel with a frame exchange in the 20-MHz control channel. The frame exchange in the extension channel is independently performed by another system which is present in an interference area of the wireless communication terminal. In the situations shown in FIGS. 12 and 13, the possibility of capturing a halfway part of a physical frame cannot be ignored.

As described above, if the wireless communication terminal conforms to CCA specified by IEEE802.11a, for detection (corresponding to detection of a significant signal) of a physical frame having a sensitivity of −82 [dBm], a preamble at the head of the physical frame must be received, and a necessary synchronizing process must be performed. Therefore, as shown in FIGS. 12 and 13, when the halfway part of the physical frame is captured, unless a signal having a sensitivity exceeding −62 [dBm] is received (corresponding to detection of an insignificant signal), the 20-MHz extension channel is determined as a channel in an empty (idle) state. If the 20-MHz control channel is also in an empty state, the entire 40-MHz channel is determined as a channel in an empty state to make it possible to transmit a 40-MHz frame. However, since the state is a state in which interference 20 [dBm] stronger than that when the physical frame can be detected may occur (i.e., a state in which a distance to an interference source is short), the probability that the transmitted 40-MHz frame is not normally received by a destination terminal increases. In contrast to this, the 40-MHz frame serves as interference, and the probability that a frame exchange performed in the extension channel is prevented also increases. In this manner, efficiency of media access control is deteriorated.

The transition mode is a mode executed when the 40-MHz channel obtained by adding the control channel and the extension channel to each other is tried to be accessed after the transmission/reception of the 20-MHz frame in the control channel. The mode has the following object. That is, in consideration of a fact that a frame head which can be detected at a high sensitivity in a normal state has been probably ended at the start of the carrier sense, a carrier sensitivity of an insignificant signal is temporarily increased to decrease the missing probability of the carrier sense, so that a collision probability between frames is reduced. Consequently, media access efficiency is improved. However, the carrier sensitivity of an insignificant signal is intentionally set to be low to prevent noise, interference, or the like from being excessively determined as busy. For this reason, when the meaning of the special treatment is diluted, the transition mode must be returned to the normal mode.

In the embodiment, it is assumed that carrier sense mode state transition (FIG. 8) is performed by the carrier sense unit 11. A signal representing the end of reception of a physical frame in a 20-MHz control channel is transmitted from the demodulating unit 10 to the carrier sense unit 11. On the other hand, a signal representing the completion of transmission of a physical frame in the 20-MHz control channel is transmitted from the modulating unit 12 to the carrier sense unit 11. A channel to be subjected to carrier sense is explicitly designated by the control unit 15 of the media access control unit 4. That is, only a 20-MHz control channel may be designated to be subject to the carrier sense, or a 40-MHz channel may be designated to be additionally subjected to the carrier sense, or carrier senses of the 40-MHz channel and the 20-MHz control channel may be designed to be always performed. The carrier sense of the 40-MHz may be obtained such that carrier sense results of the 20-MHz control channel and the 20-M extension channel are synthesized with each other. More specifically, the synthesization is performed such that the 40-MHz channel is empty (idle) only when both the channels are empty, otherwise, the 40-MHz channel is full (busy).

As shown in FIG. 8 as (event a), when a carrier sense mode is set to be a normal mode 80, the modulating unit 12 or the demodulating unit 10 notifies the carrier sense unit 11 that transmission or reception of a 20-MHz control channel is completed. At the same time, an object the carrier sense of which is started is the 40-MHz channel, the carrier sense mode shifts from the normal mode 80 to a transition mode 81.

In this manner, a threshold value of an insignificant signal is set at a value corresponding to the transition mode 81 and represented by a carrier sense determination reference (when a significant signal of the extension channel can be detected) obtained by the carrier sense mode in FIG. 9 or a carrier sense determination reference (when the significant signal of the extension channel cannot be detected) obtained by the carrier sense mode in FIG. 10. At the same time, a control channel transmission/reception elapsed time timer 114 is set.

Due to any one of factors which will be described below, when the carrier sense mode returns from the transition mode 81 to the normal mode 80, the threshold value of an insignificant signal is set at a value corresponding to the normal mode 80 and represented by the carrier sense determination reference (when the significant signal of the extension channel can be detected) by the carrier sense mode in FIG. 9 or the carrier sense determination reference (when the significant signal of the extension channel cannot be detected) by the carrier sense mode in FIG. 10.

The threshold values of the same type obtained by the carrier sense determination reference (when the significant signal of the extension channel can be detected) by the carrier sense mode in FIG. 9 or the carrier sense determination reference (when the significant signal of the extension channel cannot be detected) by the carrier sense mode in FIG. 10 may be different values depending on the channels. For example, with respect to the high threshold values, the concrete values of the high 40-M threshold value and the high 20-M threshold value are different from each other in general. In significant signal detection, in a specification related to a 20-MHz channel of, for example, IEEE802.11a, a value of −82 [dBm] is shown. This value is a sensitivity required to be satisfied by implementation. Only a case in which a signal intensity is higher than the value is not always selected to perform carrier detection. Even though a signal intensity is lower than the value, the channel is allowed to be determined as a busy channel. More specifically, even when a signal having a received signal intensity lower than that required by the specification is obtained, if a head part of the physical frame is detected from the signal, it is determined that a significant signal is detected.

As shown as (event A) in FIG. 8, when the time of the control channel transmission/reception elapsed time timer 114 exceeds predetermined time-out time, the carrier sense mode returns to the normal mode 80. Event A is established when a frame to be transmitted is not present and when an empty channel continues for a certain period of time. When a special event is not present, and when a certain period of time has elapsed, the probability of meeting a frame head even in an extension channel may increase. This is because, even though the mode returns to the normal mode 80, the probability of missing a carrier busy state decreases.

As shown as (event B) in FIG. 8, when transmission/reception in the control channel is started, the carrier sense mode is returned from the transition mode 81 to the normal mode 80, and the control channel transmission/reception elapsed time timer 114 is reset.

As shown as (event C) in FIG. 8, when transmission/reception in a 40-MHz channel is started, the carrier sense mode is returned from the transition mode 81 to the normal mode 80, and the control channel transmission/reception elapsed time timer 114 is reset. The modulating unit 12 or the demodulating unit 10 notifies the carrier sense unit 11 of the start of transmission/reception in the 40-MHz channel. When a frame exchange in the 40-MHz channel is started, upon completion of the 40-M frame, the probability of meeting a frame head even in the extension channel may increase. Therefore, even though the mode is returned to the normal mode 80, the probability of missing a carrier busy state may decrease.

As shown as “event D” in FIG. 8, a carrier is temporarily detected in the extension channel. Thereafter, when the carrier is lost, the carrier sense mode is returned from the transition mode 81 to the normal mode 80, and the control channel transmission/reception elapsed time timer 114 is reset. The loss of the carrier of the extension channel corresponds to a case in which although the value temporarily exceeds an insignificant threshold value, the level of the received signal decreases (the value need not be lower than an insignificant threshold value), and the probability of interpreting that a physical frame which cannot be decoded because the head of the frame cannot be captured is ended is high. After the frame in the extension channel is ended, the probability of meeting the frame head even in the extension channel may increase. Therefore, even though the mode is returned to the normal mode 80, the probability of missing a carrier busy state may decrease.

As shown as (event E) in FIG. 8, although a carrier is temporarily detected in a 40-MHz channel, when the carrier is lost thereafter, the carrier sense mode is returned from the transition mode 81 to the normal mode 80, and the control channel transmission/reception elapsed time timer 114 is reset. The loss of the carrier of the 40-MHz channel corresponds to a case in which, although the value temporarily exceeds an insignificant threshold value, the level of a received signal decreases (the value need not be lower than the insignificant threshold value), and the probability of interpreting that a physical frame which cannot be decoded because the head of the frame cannot be captured is ended is high. After the frame in the 40-MHz channel is ended, the probability of meeting the frame head even in the extension channel may increase. Therefore, even though the mode is returned to the normal mode 80, the probability of missing a carrier busy state may decrease.

As described above, the embodiment has the following characteristic feature. That is, a threshold value of an insignificant signal is controlled depending on a carrier sense mode in which state transition is performed, and carrier sense is performed depending on a threshold value which is dynamically controlled.

The carrier sense can be performed to the control channel, the extension channel, and the 40-MHz channel according to a carrier sense determination reference (when the significant signal of the extension channel can be detected) obtained by the carrier sense mode in FIG. 9 or a carrier sense determination reference (when the significant signal of the extension channel cannot be detected) obtained by the carrier sense mode in FIG. 10. In order to avoid a cumbersome procedure, an operation of carrier sense state transition will be described without clearly writing a channel subjected to carrier sense.

When the carrier sense state represents an idle state, transition to a busy (insignificant) state occurs when it is detected that a received signal intensity input from the RSSI unit 9 exceeds the threshold value of the insignificant signal. In this state, when the received signal intensity is lower than the insignificant threshold value, an event of carrier loss is established, and the state is returned to the idle state. The carrier loss may be designed such that the carrier loss is determined when the received signal intensity decreases by a predetermined dimension from a value of the received signal intensity at which a busy (insignificant) state is determined even though the received signal intensity exceeds the insignificant threshold value. As shown in FIG. 8, since the carrier sense mode is returned to the normal mode 80 by carrier loss, in this state, a busy (insignificant) state is not always determined again.

When the carrier sense state represents an idle state or represents a busy (insignificant) state, transition to a busy (significant) state is performed when a significant signal detection is transmitted from the demodulating unit 10 to the carrier sense unit 11. This corresponds to a situation in which the demodulating unit 10 detects the head of a physical frame, for example, L-STF at the head of a PLCP preamble by using a correlator. Furthermore, the demodulating unit 10 tries to demodulate a physical header subsequent to the head of the physical frame. If an error of a physical header is found by a parity, CRC, or the like added to the physical header, the demodulating unit 10 notifies the carrier sense unit 11 of a PHY header error.

In contrast to this, when the physical header is correctly demodulated, the demodulating unit 10 calculates duration of a physical frame from information of a transmission rate and a frame size included in the physical header. The demodulating unit 10 notifies the carrier sense unit 11 of PHY header confirmation and the transmission rate and the frame size of the PHY frame (or the calculated duration). The state of the notified carrier sense unit 11 shifts to a busy (PHY frame) state. The busy (PHY frame) state is kept for the duration of the PHY frame.

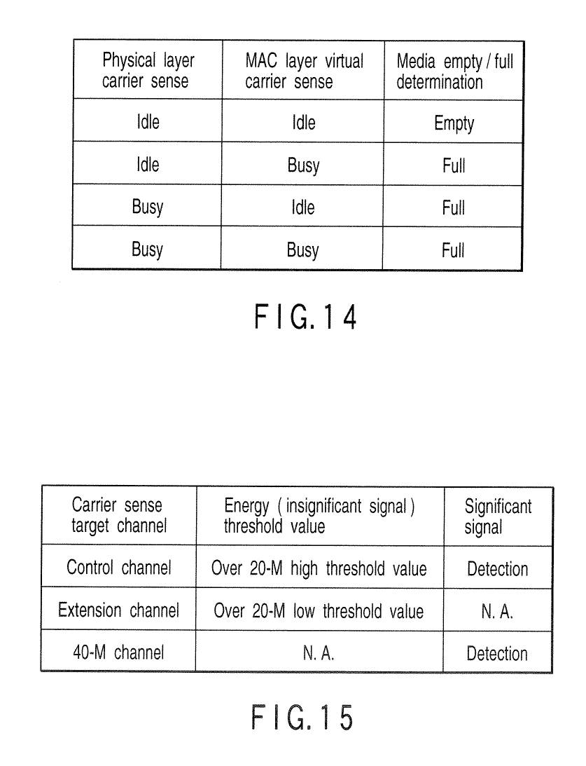

A carrier sense state of a physical layer determined by the carrier sense unit 11 is input to the receiving unit 13 of the media access control unit 4. In this state, together with a virtual carrier sense state of a MAC layer obtained by Network Allocation Vector (NAV) which is well known in IEEE802.11, a full/empty state of a media is determined by a rule the example of which is shown in FIG. 14. The media empty/full state determined as described above is transmitted from the receiving unit 13 of the media access control unit 4 to the transmitting unit 14. The transmitting unit 14 does not request the modulating unit 12 to transmit a physical frame when the media is full.

If the physical frame is lost by collision, a media access frame which is led by the physical fame is also lost. For example, as is well known in IEEE802.11, collision is detected when a transmission confirmation to the transmitted media access frame is not received within a predetermined period of time. Since the collision causes back off in media access control, efficiency of media access generally decreases.

Even though carrier sense to a channel having a band different from that of a channel having a certain band used in immediately previous frame transmission/reception and having a frequency area overlapping the frequency of the channel is performed by carrier sense mode state transition, the sensitivity of the carrier sense is controlled such that the probability of missing an interference source is low. For this reason, the probability of collision of physical frames can be reduced. In this manner, efficiency of media access can be improved.

As has been described above, in terms of an apparatus cost or operability, a function of detecting a significant signal of an extension channel may be omitted from a wireless communication apparatus. In this case, a simple carrier sense determination reference is effective as shown in FIG. 15. A significant signal of an extension channel cannot be detected, the threshold value of an insignificant signal is always lowered (sensitivity is heightened). However, the length of time for which sensitivities or signal intensities are averaged depending on environments may be adjusted such that carrier sense is prevented from being unnecessarily frequently determined as busy by noise or the like. The control channel performs normal significant signal detection and insignificant signal detection. More specifically, as long as the head of a physical frame can be captured, the sensitivity of significant signal detection is high, and the sensitivity of insignificant signal detection is low. When an insignificant signal is detected in any one of a control channel and an extension channel without performing detection of an insignificant signal of only a 40-MHz channel, it is determined that the insignificant signal is detected. The signal intensity of the extension channel may be calculated as a value obtained by subtracting a signal intensity of the control channel from a signal intensity of the 40-MHz channel. In any case, in order to detect a significant signal, filters for the 40-MHz channel and the 20-MHz control channel are necessary. However, necessity of having the filter of the 20-MHz extension channel is low. In the 40-MHz channel, a significant signal of the 40-MHz physical frame is also detected. Although this scheme is simple, since a wireless communication apparatus does not demodulate the physical frame of the extension channel, media access control must be performed without respect to a virtual carrier sense of IEEE802.11 on the extension channel side. For this reason, communication of the extension channel to be essentially protected by available carrier sense may be excessively prevented. However, this scheme adversely has a weakness for noise or interference from a system other than an IEEE802.11 system.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless communication apparatus comprising:
a first transmitting unit which transmits a physical frame to a first channel having a first bandwidth;
a second transmitting unit which transmits a physical frame to a second channel having a second bandwidth wider than the first bandwidth;
an intensity measuring unit which measures a first received signal intensity of the first channel or a second received signal intensity of the second channel;
a physical header detecting unit which detects a physical header from a received signal in which the first received signal intensity or the second received signal intensity exceeds a first threshold value;
a first carrier sense unit which obtains a first carrier sense result representing that a state in which a carrier is detected continues for a specific period of time designated by the physical header when the physical header is detected;
a second carrier sense unit which obtains a second carrier sense result representing whether a carrier is detected, by determining whether the first or second received signal intensity exceeds a second threshold value when a physical header is not detected by the physical header detecting unit;
a control unit which controls the second carrier sense unit such that the second threshold value is lowered to temporarily increase the sensitivity of carrier sense when the second carrier sense unit performs carrier sense with respect to the second channel; and
a media access control unit which controls transmission of a physical frame by the first transmitting unit and the second transmitting unit on the basis of the first carrier sense result obtained by the first carrier sense unit and the second carrier sense result obtained by the second carrier sense unit.

2. The apparatus according to claim 1, further comprising
a time measuring unit which measures elapsed time from the end of immediately previous transmission or reception of a physical frame in the first channel,
wherein the control unit controls the second threshold value depending on the value of the elapsed time given by the time measuring unit.

3. The apparatus according to claim 2, wherein
when the elapsed time is longer than predetermined time, the sensitivity of carrier sense which is temporarily increased is returned to a normal sensitivity.

4. The apparatus according to claim 1, further comprising
a collision detecting unit which detects collision between media access frames by checking whether transmission confirmation to a media access frame included in the physical frame transmitted from the first transmitting unit or the second transmitting unit is received within a predetermined period of time as a media access frame included in a received physical frame.

5. A wireless communication apparatus comprising:
a first transmitting unit which transmits a physical frame to a control channel;
a second transmitting unit which transmits a physical frame to a broad-band channel including the control channel and an extension channel;
an intensity measuring unit which measures a first received signal intensity of the control channel or a second received signal intensity of the extension channel;
a physical header detecting unit which detect a physical header from a received signal in which the first received signal intensity exceeds a first threshold value;
a first carrier sense unit which determines that a state in which a carrier is detected continues for a specific period of time designated by the physical header when the physical header is detected; and
a second carrier sense unit which determines whether a carrier is detected, by checking whether the first or second received signal intensity exceeds a second threshold value when a physical header is not detected by the physical header detecting unit,
wherein the second threshold value is set at a first value in comparison with the first received signal intensity such that a carrier sensitivity of the extension channel is always higher than the carrier sensitivity of the control channel, and the second threshold value is set at a second value lower than the first value in comparison with the second received signal intensity.

6. The apparatus according to claim 5, wherein
the carrier sensitivity of the extension channel is equal to or higher than a carrier sensitivity of the control channel obtained by the first carrier sense unit.

7. A wireless communication method comprising:
transmitting by a first transmitting unit a physical frame to a first channel having a first bandwidth;
transmitting by a second transmitting unit a physical frame to a second channel having a second bandwidth wider than the first bandwidth;
measuring by an intensity measuring unit a first received signal intensity of the first channel or a second received signal intensity of the second channel;
detecting by a physical header detecting unit a physical header from a received signal in which the first received signal intensity or the second received signal intensity exceeds a first threshold value;
obtaining a first carrier sense result representing that a state in which a carrier is detected continues for a specific period of time designated by the physical header when the physical header is detected by the physical header detecting unit;
obtaining a second carrier sense result representing whether a carrier is detected, by checking whether the first or second received signal intensity exceeds a second threshold value when a physical header is not detected by the physical header detecting unit; and
controlling, by a media access control unit, transmission of a physical frame by the first transmitting unit and the second transmitting unit, on the basis of the first carrier sense result obtained by the first carrier sense unit and the second carrier sense result obtained by the second carrier sense unit,
wherein the second carrier sense unit is controlled such that the sensitivity of carrier sense is-temporarily increased by reducing the second threshold value when the second carrier sense unit performs carrier sense of the second channel.

8. The method according to claim 7, comprising:
measuring elapsed time from the end of immediately previous transmission or reception of a physical frame in the first channel by a time measuring unit; and
controlling the second threshold value depending on the value of the elapsed time given by the time measuring unit.

9. The method according to claim 8, wherein when the elapsed time is longer than predetermined time, the sensitivity of carrier sense which is temporarily increased is returned to a normal sensitivity.

10. The method according to claim 7, further comprising
detecting collision between media access frames by checking whether transmission confirmation to a media access frame included in the physical frame transmitted from the first transmitting unit or the second transmitting unit is received within a predetermined period of time as a media access frame included in a received physical frame.

11. A wireless communication method comprising:
transmitting by a first transmitting unit a physical frame to a control channel;
transmitting by a second transmitting unit a physical frame to a broad-band channel including the control channel and an extension channel;
measuring by an intensity measuring unit a first received signal intensity of the control channel or a second received signal intensity of the extension channel;
detecting by a physical header detecting unit a physical header from a received signal in which the first received signal intensity exceeds a first threshold value;
determining that a state in which a carrier is detected continues for a specific period of time designated by the physical header when the physical header is detected by the physical header detecting unit; and
determining whether a carrier is detected, by checking whether the first or second received signal intensity exceeds a second threshold value when a physical header is not detected by the physical header detecting unit, setting the second threshold value at a first value in comparison with the first received signal intensity such that a carrier sensitivity of the extension channel is always higher than the carrier sensitivity of the control channel; and
setting the second threshold value at a second value lower than the first value in comparison with the second received signal intensity.

12. The method according to claim 11, wherein the carrier sensitivity of the extension channel is equal to or higher than a carrier sensitivity of the control channel obtained by the first carrier sense unit.
